(19) United States
(12) Patent Application Publication
(10) Pub. No.: US 2008/0024062 A1
(43) Pub. Date: Jan. 31, 2008

(54) PLASMA DISPLAY PANEL AND RELATED TECHNOLOGIES

(75) Inventors: Bo Hyun KIM, Gyeonggi-do (KR); Min Soo PARK, Seoul (KR); Deok Hai PARK, Daegu (KR); Byung Gil RYU, Seoul (KR); Young Sung KIM, Yongin-si (KR); Moon Bong SONG, Seoul (KR); Won Ki CHO, Seongnam-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/830,404

(22) Filed: Jul. 30, 2007

(30) Foreign Application Priority Data
Jul. 28, 2006 (KR) 10-2006-0071601
Jul. 28, 2006 (KR) 10-2006-0071600
Jan. 29, 2007 (KR) 10-2007-0008805

(51) Int. Cl. H01J 1/62; C01B 13/14; H01J 9/02

(52) U.S. Cl. 313/582; 423/636; 445/24

(57) ABSTRACT

A protective layer of a plasma display panel is disclosed. In the plasma display panel including a first panel and a second panel arranged to face each other while interposing barrier ribs therebetween, the plasma display panel further includes a first protective layer formed on a dielectric layer of the first panel, and a second protective layer formed on the first protective layer and containing a metallic oxide having a maximum cathode ray luminescence value within a wavelength region of 300 to 500 nanometers.

This application claims the benefit of the Korean Patent Application No. 10-2006-0071601, filed on Jul. 28, 2006, Korean Patent Application No. 10-2006-0071600, filed on Jul. 28, 2006, Korean Patent Application No. 10-2007-0008805, filed on Jan. 29, 2007, which are hereby incorporated by reference in their entireties.

### BACKGROUND

1. Technical Field

This document relates to a display apparatus with a protective layer and related technologies.

2. Discussion of the Related Art

With the advent of the multimedia age, there is demand for larger display apparatus capable of representing colors close to natural colors. To this end, a liquid crystal display (LCD), plasma display panel (PDP), projection television (TV), etc. are becoming popular rapidly in the field of a large-size high definition image.

A plasma display panel includes a lower panel having address electrodes, an upper panel having sustain electrode pairs, and discharge cells defined by barrier ribs, a phosphor being applied inside each discharge cell. In one such configuration, the discharge cells are filled with a primary discharge gas, such as neon, helium, a mixed gas of neon and helium, and the like, and an inert gas containing a small amount of xenon. If an electric discharge occurs in a discharge space between the upper panel and the lower panel, resultant vacuum ultraviolet rays are irradiated onto the phosphor of each discharge cell, to produce visible rays. With the visible rays, an image is displayed on a screen.

Both the upper panel and the lower panel of the plasma display panel are formed with dielectric layers, respectively, to protect the sustain electrode pairs and the address electrodes. However, during the occurrence of an electric discharge in the plasma display panel, the upper dielectric layer formed at the upper panel may be damaged due to a shock caused by positive ions. Therefore, the electrodes of the upper panel have a risk of being exposed and short-circuited by a metallic element such as sodium, etc.

To protect the upper dielectric layer, a protective layer is formed on the upper dielectric layer provided at the upper panel. The protective layer is formed, for example, as a coating layer of magnesium oxide (MgO) having a high resistance against a shock caused by positive ions and a high discharge coefficient of secondary electrons. With the formation of the protective layer, a drive voltage required for the plasma display panel can be lowered. Such a low drive voltage has advantages of reducing the consumption of electricity by the plasma display panel and providing the plasma display panel with improved brightness and discharge efficiency, etc.

### SUMMARY

In one general aspect, a plasma display panel includes a first panel that is arranged to face a second panel with barrier ribs interposed therebetween. The plasma display panel also includes a first protective layer positioned on the first panel and a second protective layer positioned on the first protective layer. The second protective layer includes a metallic oxide having a maximum cathode ray luminescence value within a wavelength region of 300 to 500 nanometers.

In another general aspect, a method for manufacturing a plasma display panel includes depositing a first protective layer on a dielectric layer of a first panel, and depositing, on the first protective layer, a second protective layer including a metallic oxide having a maximum cathode ray luminescence value within a wavelength region of 300 to 500 nanometers.

In yet another general aspect, a method for manufacturing magnesium oxide includes preparing magnesium gas, and supplying the magnesium gas with oxygen gas and argon gas to form a magnesium oxide single crystal.

Implementations may include one or more of the following features. For example, the metallic oxide in the second protective layer may be formed by supplying a gas-phase metallic element with 2 to 20 sccm of oxygen and 0 to 18 sccm of argon. The metallic oxide may have a greater discharge coefficient of secondary electrons than that of magnesium oxide. The metallic oxide may be single-crystal magnesium oxide powder. The single-crystal magnesium oxide powder may have a form of lumps distributed on the first protective layer. The metallic oxide may be an alkali or alkaline-earth metallic oxide. The metallic oxide may be selected from the group consisting of SrCaO, MgCaO, MgSrO, and CsI. The metallic oxide may be powder having a particle size of 50 to 1,000 nanometers.

At least a portion of the first protective layer may be exposed to a space between the first panel and the second panel. The first protective layer may have a thickness of 100 to 1,000 nanometers and the second protective layer may have a thickness of 100 to 1,500 nanometers.

The discharge delay time of the plasma display panel may be 1.2 microseconds or less. The surface discharge start voltage of the plasma display panel may be 305 volts or less, and the opposed discharge start voltage of the plasma display panel may be 250 volts or less.

The second protective layer may be deposited by vapor deposition to deposit the single-crystal metallic oxide. In order to deposit the second protective layer, a solvent, a dispersant, and asingle-crystal alkali or alkaline-earth metallic oxide powder may be pre-mixed, to prepare a second protective layer liquid. Then, the second protective layer liquid may be milled and applied on the first protective layer. The applied second protective layer liquid may be then dried and fired.

Pre-mixing the solvent, the dispersant, and the single-crystal alkali or alkaline-earth metallic oxide powder may include mixing 1 to 10 wt % of the single-crystal alkali or alkaline-earth metallic oxide powder with 90 to 99 wt % of the solvent and the dispersant. The solvent may be at least one of alcohol, glycol, propylene glycol ether, propylene glycol acetate, ketone, butyl carbitol acetate (BCA), xylene, terpineol, texanol, water, and a mixture thereof. The dispersant may be at least one of acryl, epoxy, urethane, acrylic urethane, alkyd, poly amid polymer, poly carboxylic acid (PCA), and a mixture thereof.

The milled second protective layer liquid may be applied on the first protective layer using at least one of a spray coating method, a bar coating method, a screen printing method, and a green sheet method. The second protective layer liquid may be dried at a temperature of 100 to 200 degrees centigrade, and fired at a temperature of 400 to 600 degrees centigrade.

Alternatively, in order to deposit the second protective layer, a solvent, a dispersant, and asingle-crystal magnesium oxide nano-powder may be pre-mixed, to prepare a second protective layer liquid. Then, the second protective layer liquid may be milled and applied on the first protective layer. The applied second protective layer liquid may be then dried and fired.

Pre-mixing the solvent, the dispersant, and the single-crystal magnesium oxide nano-powder may include mixing 1 to 20 wt % of the single-crystal magnesium oxide nano-powder with 80 to 99 wt % of the solvent and the dispersant.

The solvent, the dispersant, and the single-crystal magnesium oxide nano-powder may be pre-mixed by stirring the mixture for a predetermined time or by an ultrasonic dispersion. The milled second protective layer liquid may be applied onto the first protective layer using at least one of a screen printing method, a dispensing method, a photolithography method, and an ink-jet method.

The second protective layer may be deposited in the form of metallic oxide lumps distributed based on a pattern of transparent electrodes on the first panel.

Other features will be apparent from the following description, including the drawings, and the claims.

### BRIEF DESCRIPTION OF THE DRAWINGS

FIG. 1 is a view illustrating an example configuration of protective layers in a plasma display panel;

FIG. 2 is a perspective view illustrating an example configuration of discharge cells in a plasma display panel;

FIGS. 3A and 3B are graphs illustrating a surface discharge voltage and an opposed discharge voltage of plasma display panels;

FIG. 4A is a graph illustrating the jitter characteristics of plasma display panels;

FIG. 4B is a graph illustrating cathode ray luminescence characteristics of a metallic oxide constituting the protective layer of a plasma display panel;

FIG. 5 is a view illustrating an example chemical vapor deposition; and

FIG. 6 is a flow chart illustrating an example method for manufacturing a second protective layer of a plasma display panel.

### DETAILED DESCRIPTION

A plasma display panel may have a first protective film and a second protective film formed on the first protective film. The second protective film may contain a metallic oxide having a maximum cathode ray luminescence value within a wavelength region of 300 to 500 nanometers. Such a second protective film may improve jitter characteristics and discharge efficiency of the plasma display panel.

The metallic oxide of the second protective layer may be distributed on the first protective layer in the form of lumps. Such distribution may form an uneven surface. Thus, during a gas discharge in the plasma display panel, ultraviolet ions collide with the protective layer in an increase surface area, which increases the discharge amount of secondary electrons and lowers a discharge start voltage. This further improves jitter characteristics and discharge efficiency of the plasma display panel.

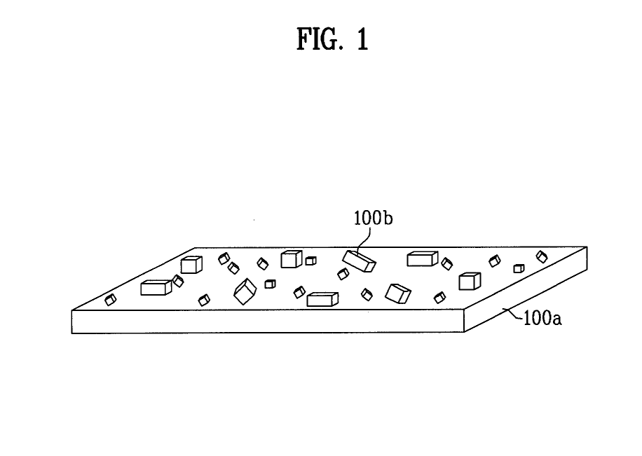

FIG. 1 is a view illustrating an example configuration of protective layers in a plasma display panel.

A first protective layer 10a is formed on a dielectric layer (not shown). The first protective layer 100a is made of magnesium oxide, and additionally, a dopant may be contained in the first protective layer 100a. The dopant has the function of improving the discharge characteristics of secondary electrons included in the protective layer and reducing the delay of a discharge. The dopant may be selected from the group consisting of aluminum (Al), chrome (Cr), hydrogen (H₂), silicon (Si), scandium (Sc), and gadolinium (Gd). The first protective layer 100a may have a thickness of 100 to 1,000 nanometers. Preferably, to reduce a jitter value, the dopant contained in the first protective layer 100a may be in an amount of 20 to 500 parts per million (ppm).

A second protective layer 100b is formed on the first protective layer 100a. The second protective layer 100b may contain a metallic oxide. The metallic oxide has a maximum cathode ray luminescence value within a wavelength region of 300 to 500 nanometers. Also, the metallic oxide may be produced by supplying a gas-phase metallic element with 2 to 20 sccm of oxygen and 0 to 18 sccm of argon. The second protective layer 100b made of a metallic oxide improves jitter characteristics and discharge efficiency while the first protective layer 100a protects a dielectric layer from a shock caused by positive ions. The second protective layer 100b may have a thickness of 100 to 1,500 nanometers. The metallic oxide may have a particle size of 50 to 1,000 nanometers.

The metallic oxide in the second protective layer 100b may be single-crystal magnesium oxide powder or an alkali or alkaline-earth metallic oxide. As shown in the following Table 1, the protective layer containing an alkali or alkaline-earth metallic oxide has a greater discharge coefficient of secondary electrons than a protective layer containing only magnesium oxide.

TABLE 1

| Deposition | | Discharge Coefficient |
|---|---|---|
| Method | Protective Layer | of Secondary Electrons |
| E-beam | MgO | 0.33 |
| | MgO + Alkali metal | 0.53˜0.60 |
| Sputtering | MgO | 0.40 |
| | MgO + Alkaline-earth | 0.56˜0.62 |
| | metal | |

Specifically, the metallic oxide may be selected from the group consisting of SrCaO, MgCaO, MgSrO and CsI. The metallic oxide, constituting the second protective layer 100b, may be located only on a part of the first protective layer 100a. More specifically, the metallic oxide may have the form of lumps distributed on the first protective layer 100a. The metallic oxide is patterned on the first protective layer 100a according to the pattern of transparent electrodes and provides the first protective layer 100a with an uneven surface. Accordingly, during the occurrence of a gas discharge in a plasma display panel, ultraviolet ions collide with the protective layer over an increased surface area of the protective layer, whereby the discharge amount of secondary electrons can be increased and the discharge start voltage can be lowered. This consequently has the effects of improving the discharge efficiency and jitter characteristics. These effects can be further enhanced when the metallic oxide constituting the second protective layer 100b has a greater discharge coefficient of secondary electrons than that of magnesium oxide of the first protective layer 100a.

The metallic oxide, constituting the second protective layer 100b, may have the form of lumps distributed based on the pattern of transparent electrodes in a plasma display panel. In addition to protecting the transparent electrodes, the metallic oxide also has the function of converting vacuum ultraviolet rays having a wavelength of 147 nanometers, which is produced by a discharge gas such as xenon (Xe) during a discharge of the plasma display panel, into ultraviolet rays having a wavelength of 250 nanometers, and consequently, improving the brightness of the plasma display panel.

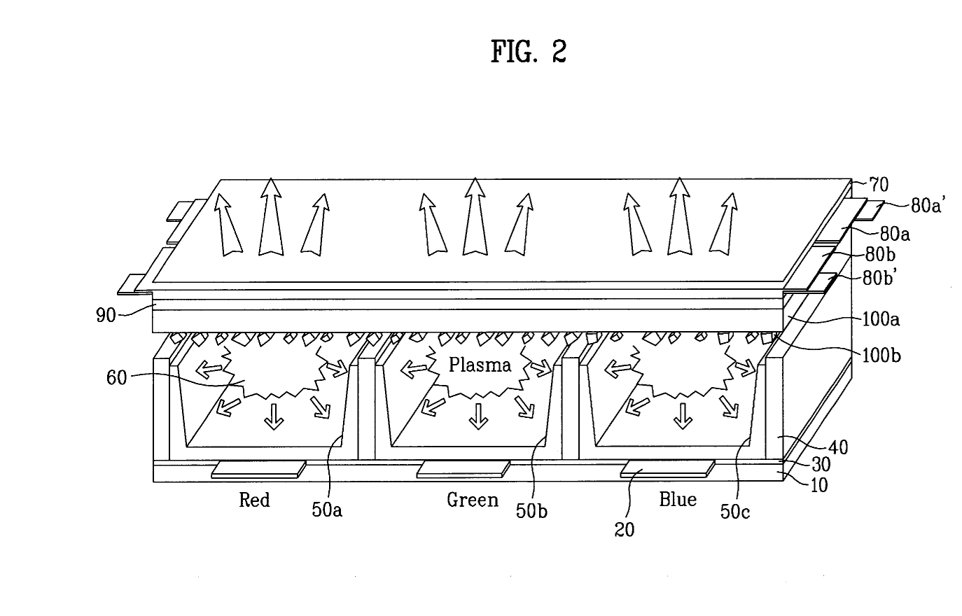

FIG. 2 is a perspective view illustrating an example configuration of discharge cells in a plasma display panel.

The plasma display panel in FIG. 2 includes an upper panel and a lower panel, which are arranged to face each other with barrier ribs therebetween. The upper panel includes an upper substrate 70 having an image display surface, and sustain electrode pairs 80 arranged on the upper substrate 70, each sustain electrode pair consisting of a pair of transparent electrodes 80a and 80b and a pair of bus electrodes 80a′ and 80b′. The lower panel includes a lower substrate 10, and address electrodes 20 arranged on the lower substrate 10 to intersect the above described sustain electrode pairs. The upper panel and the lower panel are parallel to each other with a predetermined distance therebetween.

To form a plurality of discharge spaces, i.e. discharge cells, the stripe type or well type barrier ribs 40 are arranged parallel to one another on the lower panel. The plurality of address electrodes 20 are arranged parallel to the barrier ribs, to generate vacuum ultraviolet rays by performing an address discharge. Red, Green, and Blue phosphors 50a, 50b, and 50c are applied onto an upper surface of the lower panel, to discharge visible rays for displaying an image during the address discharge. A lower dielectric layer 30 is formed between the address electrodes 20 and the phosphors 50a, 50b, and 50c, to protect the address electrodes 20.

An upper dielectric layer 90 is formed on the sustain electrode pairs, and the first protective layer 100a and the second protective layer 100b are formed on the upper dielectric layer 90 in sequence. The detailed characteristics of the first and second protective layers 100a and 100b are as described above. Positive ions are produced while a discharge occurs in the discharge spaces, and the first protective layer 100a, which is made of magnesium oxide, etc., protects the upper dielectric layer 90. Also, the second protective layer 100b, which is in contact with the discharge spaces, is made of magnesium oxide, etc., to achieve an improvement in discharge characteristics as described above.

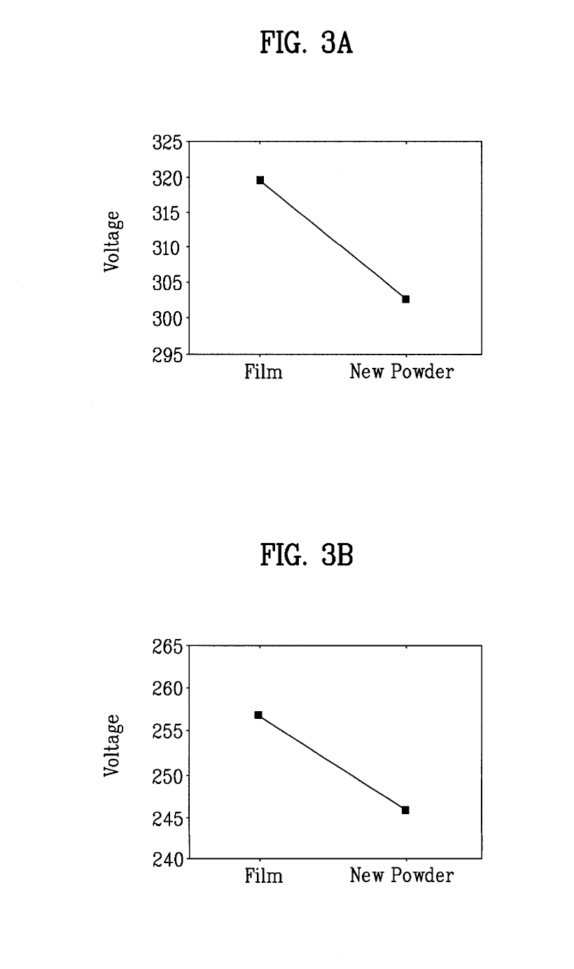

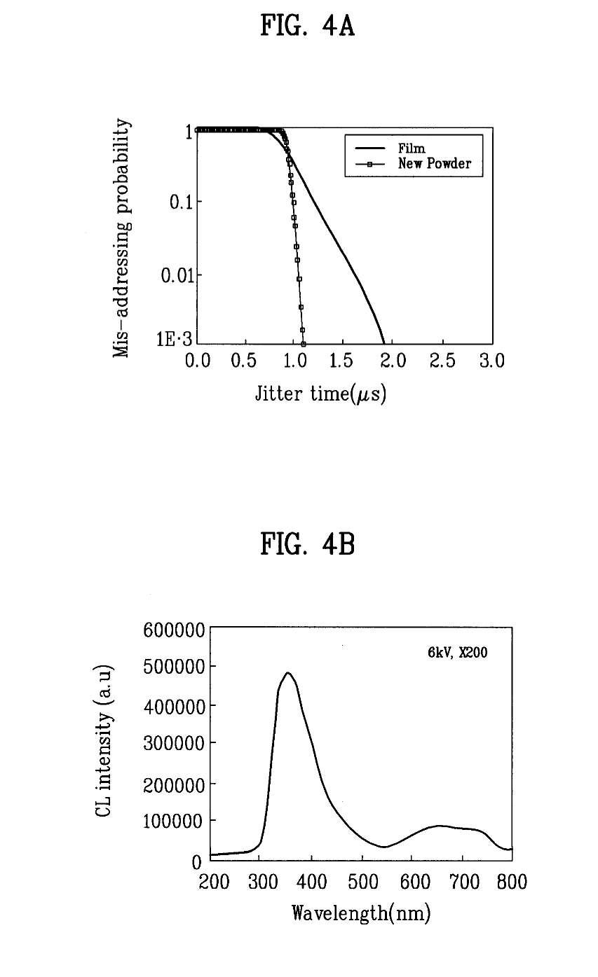

FIGS. 3A and 3B are graphs illustrating a surface discharge voltage and an opposed discharge voltage of plasma display panels. FIG. 4A is a graph illustrating the jitter characteristics and FIG. 4B is a graph illustrating the cathode ray luminescence characteristics.

As shown in FIG. 3A, a plasma display panel with a single protective film (represented as “Film” in FIG. 3A) causes a surface discharge at approximately 320 volts. The plasma display panel of FIG. 2 with a second protective film containing metallic oxide (represented as “New Powder” in FIG. 3A) causes a surface discharge at 305 volts or less. Also, as shown in FIG. 3B, the plasma display panel with a single protective film causes an opposed discharge at approximately 258 volts, but the plasma display panel of FIG. 2 with a second protective film containing metallic oxide causes an opposed discharge at 250 volts or less. Accordingly, the two protective film structure with the second protective film containing metallic oxide has the effect of lowering a discharge start voltage, thereby lowering the consumption of electricity by the plasma display panel.

Discharge characteristics of the plasma display panel having a single film type protective layer and the plasma display panel having a metallic oxide type protective layer (two protective film structure) are shown in the following Table 2.

TABLE 2

| | Film | Metallic Oxide |
|---|---|---|
| Surface Discharge | 320 V | 303 V |
| Opposed Discharge | 258 V | 247 V |

FIG. 4A is a graph illustrating the jitter characteristics of the plasma display panels. As shown in FIG. 4A, the plasma display panel having a single film type protective layer has a discharge delay time of approximately 2 microseconds, but the plasma display panel having a metallic oxide type protective layer has a discharge delay time of 1.2 microseconds or less. The jitter characteristics of the single film type protective layer of the plasma display panel and the metallic oxide type protective layer of the plasma display panel are shown in further detail in the following Table 3.

TABLE 3

| | Film | Metallic Oxide |
|---|---|---|
| T_{99.9} | 2.265 | 1.115 |
| T_{f} | 0.600 | 0.785 |
| T_{avg} | 0.982 | 0.928 |
| Sigma | 0.249 | 0.054 |
| T_{sc6z} | 2.477 | 1.252 |

It can be appreciated from the above Table 3 that the single film type protective layer (second column in Table 3) has a slightly faster formative time T_{f}, but other time factors are more shortened in the metallic oxide type protective layer (third column in Table 3), resulting in a reduction in the overall discharge delay time of the metallic oxide type protective layer. Such an improvement in jitter characteristics is accomplished, in part, because a metallic oxide contained in the second protective layer has a maximum cathode ray luminescence value within a wavelength region of 300 to 500 nanometers.

Hereinafter, a method for manufacturing a plasma display panel will be described. The method is to manufacture the plasma display panel having the above described configuration.

First, a first protective layer is deposited on a dielectric layer that was previously formed on an upper panel. The first protective layer may be formed by any one method selected from among a spray method, a coating method, a chemical vapor deposition (CVD) method, an electronic beam (E-beam) method, an ion-plating method, a sol-gel method, a sputtering method, and the like. The first protective layer is formed close to the dielectric layer, to protect the dielectric layer from a shock caused by positive ions, etc. To achieve the above described characteristics, the first protective layer may have a thickness of 100 to 1,000 nanometers. If the thickness of the first protective layer is less than 100 nanometers, there is a risk of an erroneous discharge. On the other hand, if the thickness of the first protective layer is more than 1,000 nanometers, it may cause problems in manufacturing processes and costs. The first protective layer contains magnesium oxide, and additionally, may contain a dopant. If the dopant is added, it has the effect of lowering a jitter value during an address discharge period. However, if the content of the dopant exceeds a predetermined value or more, it may disadvantageously increase the jitter value. Therefore, the doping of the dopant is performed within a range to reduce the jitter value to the maximum extent. For example, the dopant is contained in the protective layer in an amount of 20 to 500 ppm.

The deposition of the first protective layer using an electronic beam (E-beam) method will be described as an example. First, a first source material as a constituent material of the first protective layer is prepared. As described above, the first source material may include magnesium oxide and a slight amount of dopant, and the dopant is selected from the group consisting of Al, Cr, H₂, Si, Sc and Gd. Although the first source material may be provided as a single source material obtained by doping the above described dopant in magnesium oxide, the magnesium oxide and the dopant may be prepared separately. Subsequently, the above described first source material is heated at a high temperature, to deposit the first protective layer on the dielectric layer by use of a physical energy.

Then, the second protective layer is deposited on the first protective layer by any one method selected from a spray method, a coating method, a chemical vapor deposition (CVD) method, an electronic beam (E-beam) method, an ion-plating method, a sol-gel method, a sputtering method, and the like. The deposition of the second protective layer using the chemical vapor deposition method will be described, as an example. The second protective layer contains a single-crystal metallic oxide having a maximum cathode ray luminescence value within a wavelength region of 300 to 500 nanometers. The metallic oxide is obtained by supplying a gas-phase metallic element with 2 to 20 sccm of oxygen and 0 to 18 sccm of argon.

First, a second source material as a constituent material of the second protective layer is prepared. Here, the second source material may consist of only magnesium oxide. The second protective layer is formed on the first protective layer by use of steam generated by heating the second source material. In this case, the magnesium oxide is deposited to have a single crystal structure.

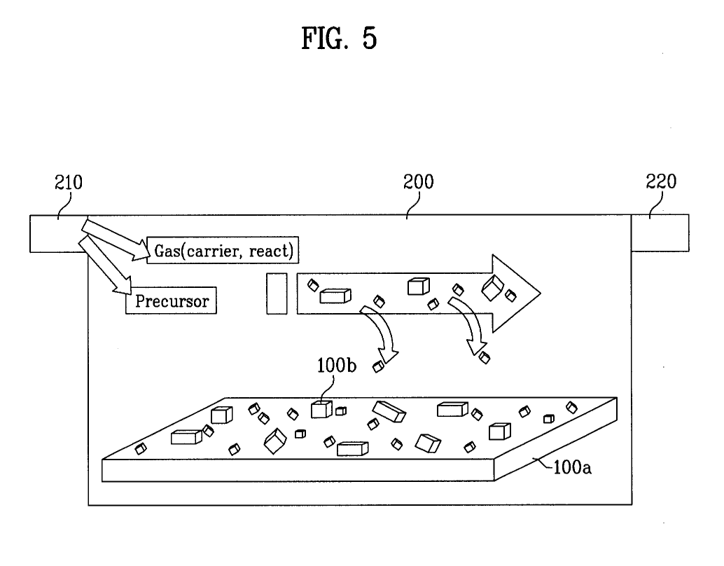

FIG. 5 is a view illustrating an example chemical vapor deposition apparatus in one implementation.

The chemical vapor deposition apparatus includes a chamber, a temperature regulator, and a controller. As shown in FIG. 5, the chamber 200 includes an inlet portion 210 for injecting a source material, etc. into the chamber 200, and an outlet portion 220 for discharging the source material, etc. to the outside. Also, although not shown in FIG. 5, the chamber 200 is provided with the temperature regulator for regulating the interior temperature of the chamber 200 and the controller for regulating the flow rates of a carrier gas and a reaction gas within the chamber 200.

After the upper panel of the plasma display panel with the first protective layer 100a is put into the chamber 200, the second protective layer 100b is formed via the chemical vapor deposition method. In this case, a carrier gas, a reaction gas, a precursor, and a source material are injected into the chamber 200. The source material is, for example, magnesium-oxide, to facilitate the growth of magnesium oxide crystals. The carrier gas may be nitrogen or hydrogen, and the reaction gas may be any one of oxygen, hydrogen, nitrogen, and argon.

In the process for forming the second protective layer on the first protective layer, nucleus generation sites are formed on the first protective layer, and a magnesium oxide single crystal is grown from each of the sites. Each magnesium oxide single crystal has an irregular shape, and thus, the overall protective layer has an uneven surface. In this case, the second protective layer preferably has a thickness of 100 to 1,500 nanometers. To satisfy the above described characteristics, the flow rates of the carrier gas and the reaction gas are regulated by the controller, and the interior temperature of the chamber is regulated by the temperature regulator.

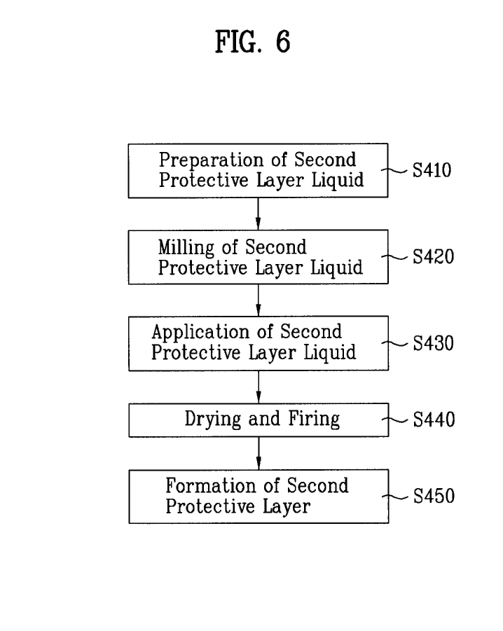

The above described second protective layer may be deposited by a liquid phase deposition method, rather than the chemical vapor deposition method. Hereinafter, the deposition of the second protective layer using the liquid phase deposition method will be described referring to FIG. 6.

FIG. 6 is a flow chart illustrating an example method for manufacturing a second protective layer of a plasma display panel.

The method of FIG. 6 may be used to form a second protective layer having alkali or alkaline-earth metallic oxide or a second protective layer having magnesium oxide. First, the formation of the second protective layer using an alkali or alkaline-earth metallic oxide will be described.

As shown in FIG. 6, a second protective layer liquid is prepared by pre-mixing a solvent, a dispersant, and single-crystal metallic oxide powder (S410). The metallic oxide may be an alkali or alkaline-earth metallic oxide. Here, 1 to 10 wt % of the single-crystal metallic oxide powder is mixed with 90 to 99 wt % of the solvent and the dispersant. The solvent may be an alcohol, glycol or diol, propylene glycol ether, propylene glycol acetate, ketone, butyl carbitol acetate (BCA), xylene, terpineol, texanol, water, or a mixture thereof. The dispersant may be acryl, epoxy, urethane, acrylic urethane, alkyd, poly amid polymer, poly carboxylic acid, or a mixture thereof.

Subsequently, the prepared second protective layer liquid is subjected to a milling process (S420). Here, the milling of the second protective layer liquid is performed by a milling machine.

The pre-mixing for the preparation of the second protective layer liquid is continued for 1 to 10 minutes at 2,000 to 4,000 rpm. The milling of the second protective layer liquid is continued for 10 to 60 minutes at 6,000 to 10,000 rpm. The solvent, the dispersant, and the single-crystal metallic oxide powder are mixed by stirring for a predetermined time (for example, for an hour), and are subjected to an ultrasonic distribution using an ultrasonic distributor, to thereby form the second protective layer liquid.

Next, the milled second protective layer liquid is applied onto the overall surface of the first protective layer by any one method selected from a spray coating method, a bar coating method, a screen printing method, and a green sheet method (S430). Thereafter, the second protective layer liquid, applied onto the first protective layer, is dried and fired (S440), to form the second protective layer (S450). Here, depending on the type of the solvent, the drying is performed at a temperature of 100 to 200 degrees centigrade, and the firing is performed at a temperature of 400 to 600 degrees centigrade. Thereby, particles including the single-crystal metallic oxide powder remain irregularly, in the form of lumps, on the overall surface of the first protective layer, to form the second protective layer.

The method of FIG. 6 may also be used to form a second protective layer having magnesium oxide. Hereinafter, a process for forming the second protective layer via the deposition of the single-crystal magnesium oxide powder will be described, with reference to FIG. 6.

First, a solvent, a dispersant, and single-crystal magnesium oxide (MgO) nano-powder are pre-mixed, to prepare a second protective layer liquid (S410). Here, 1 to 20 wt % of the single-crystal magnesium oxide nano-powder is mixed with 80 to 99 wt % of the solvent and the dispersant. The solvent may be an alcohol, glycol or diol, propylene glycol ether, propylene glycol acetate, ketone, butyl carbitol acetate (BCA), xylene, terpineol, texanol, water, or a mixture thereof. The dispersant may be acryl, epoxy, urethane, acrylic urethane, alkyd, poly amid polymer, poly carboxylic acid, or a mixture thereof.

Subsequently, the solvent, the dispersant, and the single-crystal magnesium oxide nano-powder are mixed by stirring for a predetermined time (for example, for a hour), and are subjected to an ultrasonic dispersion using an ultrasonic distributor, to thereby form the second protective layer liquid. Next, the second protective layer liquid is subjected to a milling process (S420). The milling of the second protective layer liquid is performed by a milling machine. Next, the milled second protective layer liquid is applied onto the first protective layer by any one method selected from a screen printing method, a dispensing method, a photolithography method, and an ink-jet method (S430).

The second protective layer liquid, applied onto the first protective layer, is dried and fired (S440), to form the second protective layer (S450). Depending on the type of the solvent, the drying is performed at a temperature of 100 to 200 degrees centigrade, and the firing is performed at a temperature of 400 to 600 degrees centigrade. Thereby, particles including the single-crystal metallic oxide nano-powder remain, in the form of lumps, on the first protective layer, to form the second protective layer.

Before forming the first and second protective layers, two transparent electrodes (ITO) are formed on the upper substrate, and in turn, bus electrodes as auxiliary electrodes are deposited on the respective transparent electrodes, to form discharge cell sustain electrodes. Next, an upper dielectric layer is formed over the above electrodes. After that, a first protective layer and a second protective layer are formed on the dielectric layer in sequence.

The manufacture of a lower substrate includes forming address electrodes on a glass substrate, forming a lower dielectric layer for the protection of the address electrodes, forming barrier ribs on an upper surface of the lower dielectric layer to divide discharge cells from one another, and forming a phosphor layer between the barrier ribs for discharging visible rays required for the display of an image.

Subsequently, a sealing material is applied onto the lower substrate to bond the lower substrate to the upper substrate. In this way, the manufacture of the plasma display panel is completed.

Other implementations are within the scope of the following claims.

What is claimed is:

1. A plasma display panel including a first panel that is arranged to face a second panel with barrier ribs interposed therebetween, the plasma display panel, comprising:
a first protective layer positioned on the first panel; and a second protective layer positioned on the first protective layer and including a metallic oxide having a maximum cathode ray luminescence value within a wavelength region of 300 to 500 nanometers.

2. The plasma display panel according to claim 1, wherein the metallic oxide in the second protective layer is formed by supplying a gas-phase metallic element with 2 to 20 sccm of oxygen and 0 to 18 sccm of argon.

3. The plasma display panel according to claim 1, wherein the metallic oxide in the second protective layer is single-crystal magnesium oxide powder.

4. The plasma display panel according to claim 3, wherein at least a portion of the first protective layer is exposed to a space between the first panel and the second panel.

5. The plasma display panel according to claim 3, wherein the single-crystal magnesium oxide powder has a form of lumps distributed on the first protective layer.

6. The plasma display panel according to claim 1, wherein a discharge delay time of the plasma display panel is 1.2 microseconds or less.

7. The plasma display panel according to claim 1, wherein a surface discharge start voltage of the plasma display panel is 305 volts or less, and an opposed discharge start voltage of the plasma display panel is 250 volts or less.

8. The plasma display panel according to claim 1, wherein the metallic oxide is an alkali or alkaline-earth metallic oxide.

9. The plasma display panel according to claim 8, wherein the metallic oxide is selected from the group consisting of SrCaO, MgCaO, MgSrO, and CsI.

10. The plasma display panel according to claim 1, wherein the metallic oxide is powder having a particle size of 50 to 1,000 nanometers.

11. The plasma display panel according to claim 1, wherein the first protective layer has a thickness of 100 to 1,000 nanometers.

12. The plasma display panel according to claim 1, wherein the second protective layer has a thickness of 100 to 1,500 nanometers.

13. The plasma display panel according to claim 1, wherein the metallic oxide has a greater discharge coefficient of secondary electrons than that of magnesium oxide.

14. A method for manufacturing a plasma display panel comprising:
depositing a first protective layer on a dielectric layer of a first panel; and
depositing, on the first protective layer, a second protective layer including a metallic oxide having a maximum cathode ray luminescence value within a wavelength region of 300 to 500 nanometers.

15. The method according to claim 14, wherein depositing the second protective layer includes depositing a second protective layer that includes a single-crystal metallic oxide.

16. The method according to claim 15, wherein depositing the second protective layer includes performing vapor deposition to deposit the single-crystal metallic oxide.

17. The method according to claim 16, wherein the single-crystal metallic oxide is formed by supplying a gas-phase metallic element with 2 to 20 sccm of oxygen and 0 to 18 sccm of argon.

18. The method according to claim 15, wherein the deposition of the second protective layer comprises:
pre-mixing a solvent, a dispersant, and asingle-crystal alkali or alkaline-earth metallic oxide powder, to prepare a second protective layer liquid;
milling the second protective layer liquid;
applying the milled second protective layer liquid on the first protective layer; and
drying and firing the second protective layer liquid.

19. The method according to claim 18, wherein pre-mixing the solvent, the dispersant, and the single-crystal alkali or alkaline-earth metallic oxide powder comprises mixing 1 to 10 wt % of the single-crystal alkali or alkaline-earth metallic oxide powder with 90 to 99 wt % of the solvent and the dispersant.

20. The method according to claim 18, wherein the solvent is at least one of alcohol, glycol, propylene glycol ether, propylene glycol acetate, ketone, butyl carbitol acetate (BCA), xylene, terpineol, texanol, water, and a mixture thereof.

21. The method according to claim 18, wherein the dispersant is at least one of acryl, epoxy, urethane, acrylic urethane, alkyd, poly amid polymer, poly carboxylic acid (PCA), and a mixture thereof.

22. The method according to claim 18, wherein applying the milled second protective layer liquid on the first protective layer includes applying the milled second protective layer liquid using at least one of a spray coating method, a bar coating method, a screen printing method, and a green sheet method.

23. The method according to claim 18, further comprising:
drying the second protective layer liquid at a temperature of 100 to 200 degrees centigrade, and
firing the second protective layer at a temperature of 400 to 600 degrees centigrade.

24. The method according to claim 15, wherein the deposition of the second protective layer comprises:
pre-mixing a solvent, a dispersant, and asingle-crystal magnesium oxide nano-powder, to prepare a second protective layer liquid;
milling the second protective layer liquid;
applying the milled second protective layer liquid on the first protective layer; and
drying and firing the second protective layer liquid.

25. The method according to claim 24, wherein pre-mixing the solvent, the dispersant, and the single-crystal magnesium oxide nano-powder comprises mixing 1 to 20 wt % of the single-crystal magnesium oxide nano-powder with 80 to 99 wt % of the solvent and the dispersant.

26. The method according to claim 24, wherein pre-mixing the solvent, the dispersant, and the single-crystal magnesium oxide nano-powder comprises stirring the mixture for a predetermined time or by an ultrasonic dispersion.

27. The method according to claim 24, wherein applying the milled second protective layer liquid onto the first protective layer includes applying the milled second protection layer liquid using at least one of a screen printing method, a dispensing method, a photolithography method, and an ink-jet method.

28. The method according to claim 14, wherein depositing the second protective layer comprises deposing a second protective layer having a form of metallic oxide lumps distributed based on a pattern of transparent electrodes on the first panel.

29. A method for manufacturing magnesium oxide comprising:
preparing magnesium gas; and
supplying the magnesium gas with oxygen gas and argon gas, to form a magnesium oxide single crystal.

30. The method according to claim 29, wherein the oxygen gas is supplied at a flow rate of 2 to 20 sccm, and the argon gas is supplied at a flow rate of 0 to 18 sccm.
